(19) United States
(12) Patent Application Publication
(10) Pub. No.: US 2006/0178890 A1
(43) Pub. Date: Aug. 10, 2006

(54) Method for automating the implementation and updating of an information system

(76) Inventors: Paul Saravanane Marechal, Savigny le Temple (FR); Emilie Michele Wastyn, Savigny le Temple (FR)

Correspondence Address: BROWDY AND NEIMARK, P.L.L.C.;624 NINTH STREET, NW, SUITE 300, WASHINGTON, DC, 20001-5303, US

(21) Appl. No.: 10/547,702

(22) PCT Filed: Mar. 2, 2004
(86) PCT No.: PCT/FR04/00492

§ 371 Date: Sep. 2, 2005

(30) Foreign Application Priority Data
Mar. 4, 2003 (FR) 03/02810

(51) Int. Cl. G06Q 99/00

(52) U.S. Cl. 705/1; 706/920

(57) ABSTRACT

The invention relates to a method of automating the implementation and updating of an information system. The inventive method comprises the following phases: an electronic specifications phase (Block 1) corresponding to a first status of a given version of the information system; a phase involving the automatic generation (Block 2) of the information system, corresponding to a second status of a given version of the information system; and an on-lining phase (Block 5) corresponding to a third status of a given version of the information system, said version being deployed using different execution channels. Moreover, if any change is made to the information system after the on-lining phase, the invention also comprises an adaptation phase (Block 7) consisting in returning to the electronic specifications phase. The aforementioned method automatically controls the statuses of the different versions of the information system in relation to one another. The invention is particularly suitable for managing a company's information flows.

The present invention relates to a method for automating the implementation and updating of an information system. More particularly it is applied but not exclusively to the management of information flows of corporations.

Generally, the architecture of a corporate information system may comprise:
a business process management system called BPM hereafter,
an actual information system (IS),
a system for integrating corporate applications (enterprise application integration) called EAI hereafter,
a workflow engine.

The information system is the main system which stores the data of the corporation and represents its operation. Ideally, the information system should integrate the business processes (the activities) of the corporation in all its sectors or divisions (sales, customer services, accounting, human resources . . . ), it being understood that a sector or division may be characterized by a set of business processes.

In a corporation, there may be several information systems for covering all the needs and one or more information systems for a single sector.

In a corporation, the employees (also called actors) work, collaborate in different activities.

All these actors, in different departments of the corporation, work by using certain common items which are also called business objects. Consequently, it is necessary to have the information systems communicate with each other in order to have a general view of these business objects.

Before EAIs appeared, the information systems were interconnected with each other, one by one. When there were more than two information systems then the number of interfaces was increasing factorially which posed considerable problems for implementation and maintenance. The goal of the EAI is to centralize exchanges between information systems in order to reduce the maintenance of the interfaces. Among the known examples of EAIs, WebMethods, Crossworlds . . . , may be mentioned.

On the other hand, with an EAI, data cannot be stored.

Thus, it may be stated that the different business processes of different sectors are connected with each other. As EAI is the system which provides connection of the information systems, it should be aware of the links existing between the different processes and the nature of the data to be transmitted.

To facilitate the modeling of connections between processes, there exist tools, these are the BPMs (for example W4, Rational Rose, System Architect, Microsoft Visio). They are used for documenting business processes of the corporation. For lack of these tools, office software (Microsoft Word, PowerPoint . . . ) are used for modeling them.

It should be noted that with EAIs and BPMs, it is not possible to act on the integrated business processes in each information system. Indeed, like the workflow engines, they are only components of the architecture of an information system but they cannot form an information system by themselves.

Consequently, one must directly intervene at the information system in order to manage the business processes. Indeed, it is the information system which supports their execution.

These business processes describe the operation of the corporation and notably relate to sales, customer services, marketing, accounting, purchase order control, inventory control, logistics, etc.

Different types of information systems may be contemplated:
Information systems comprising pre-integrated business processes do not provide any adaptation. Now, the latter are very rigid and really correspond to the needs and actual operation of the corporation;
A totally opposite solution corresponds to the complete elaboration of a tailored system. However, this approach is very expensive and is only valid at a given time. Indeed, as soon as a business process is changed, it is all the system(s) in which it is involved which should be changed, which implies resuming the elaboration cycle in order to produce an update thereby involving new costs. Maintenance of an information system is therefore very complex and it becomes a curb to change the business process of the corporation. Generally, the changes to be carried out in the system are brought together while waiting for a next version.
An intermediate solution consists of using a predefined system, supporting a few generic business processes and adapting it, this is what is called the integration phase of the information system. This phase requires the collecting of information, the business processes of the corporation, their transposition into functional and then technical specifications, their actual integration into the information system in order to change it and then to change it and to carry out the commissioning of the thereby altered system. This integration is done manually and takes on the average nineteen days with nine consultants (source: IDC, Systems Integration Services for the Middle Market: Four Case Studies That Challenge the Myths, Stéphanie M. Torto, 2002). By manually, it is meant that each step of the method is carried out and reported independently of the other ones and that it is necessary to intervene in order to have the information transit with risks of errors notably due to the updates which are moreover always difficult to implement.

Moreover, implementation of an information system is all the more longer that different channels are involved for allowing execution of business processes. The cost and the time of analysis of the integration of the business processes, of the interfacing of the different applications (either involving or not an EAI) are all the more important and complex as the activities of the business process are nested and as the number of channels to be applied is large.

Indeed, the different actors involved in a business process execute activities which are assigned to them in different communication channels: for example the customers may use the e-commerce site of the corporation, whereas the sales agents use a mobile application from a portable computer during their travel, deliverymen use an application on a portable terminal (of the Palm Pilot type) allowing them to track deliveries to be carried out which they synchronize upon their return, etc. A different computer application is today used for each execution channel. One of the difficulties of integration is the communication between these different applications.

The object of the invention is to suppress these drawbacks via a method with which it is automatically possible to both generate an information system and update it in real time notably by dividing the time for integrating the business processes into the system by three, this method being able to manage processes using several execution channels.

For this purpose, it proposes a method for automating the implementation and updating of an information system comprising the following phases:
an electronic specification phase corresponding to a first so-called “specification” status for a given version of the information system, and notably comprising a modeling of the business processes, said business process modeling including a definition of the workflows and a definition of the responsibilities,
a phase for automatically generating the information system from electronic specifications corresponding to a second so-called “test” status of a given version of the information system,
a commissioning phase corresponding to a third so-called “operation” status of a given version of the information system and including automatic deployment of said operational version of the information system on different execution channels,
if a change in the information system is provided after commissioning, an adaptation phase including returning to the electronic specification phase and thus creating the “specification” status of a new version of the information system, this method automatically managing the statuses of the different versions of the information system relatively to each other.

In addition, changes brought to the modeled business processes and consequently to the information system may be implemented in real time.

Advantageously, said management of statuses and versions may notably allow that a version has an operation status while another version has the specification status and this without any possible confusion.

The phase of electronic specifications may comprise the definition of work screens for different users.

The electronic specifications comprise a detailed description with a very fine grain size so that all the information for generating the information system is included.

During the modeling of the business processes, the execution channel(s) of each activity are taken into account in order to be able to automatically generate the adequate items of the information system.

Indeed, the business processes are end-to-end processes, i.e., the complete chain of the business processes may be represented, regardless of the channel used for executing activities.

Advantageously, management and distribution of specification documents may be carried out from electronic specifications, automatically.

There may be tests before the commissioning phase for example, a conformity test, a validation test.

It should be noted that insofar the information system was automatically generated from model data, it is compliant by default, i.e., it exactly corresponds to said data, which makes any compliance tests unnecessary.

The validation test takes place on a version of the information system, corresponding to a test status, isolated but identical with the one which will be commissioned.

The validation test may consist of having a manager from the corporation check that no error or omission concerning a business process has been made. He/she will also check the consistency of the business process.

Test scenarii may be defined for the validation test.

If the result of the test is positive, the commissioning phase of the information system may start and the version of the information system switches to an operation status.

If the test is negative, there is a return to the electronic specification phase and to repeating the following phases until the test is positive.

Modeling the business processes by taking into account the execution channels of each activity during the generation of the information system may allow items for each channel to be generated, such as work screens, synchronization functions.

For example, the simple fact of defining an activity via a web channel upon generating the SI, will allow work screens and functions required within the e-commerce site, to be generated. Also, if an activity is defined as being an activity via a manual terminal channel for example of the Palm® type, then the application will automatically generate work screens and synchronization functions required on a manual terminal, and so forth.

The commissioning phase comprises the replication of the last version of the test of information system, i.e., in the test status on a corporation server and then its automatic deployment on different terminals or client stations.

Said deployment on client stations may be directly performed from a user identifier thereby giving restricted access, adapted to a certain number of activities, i.e., exclusively giving access to activities under the responsibility of the user.

After deploying a new version of the information system following a change, for example of a business process, the client stations may automatically detect a new version of the information system and thus be updated.

Embodiments of the invention will be described hereafter, as non-limiting examples, with reference to the appended drawings wherein:

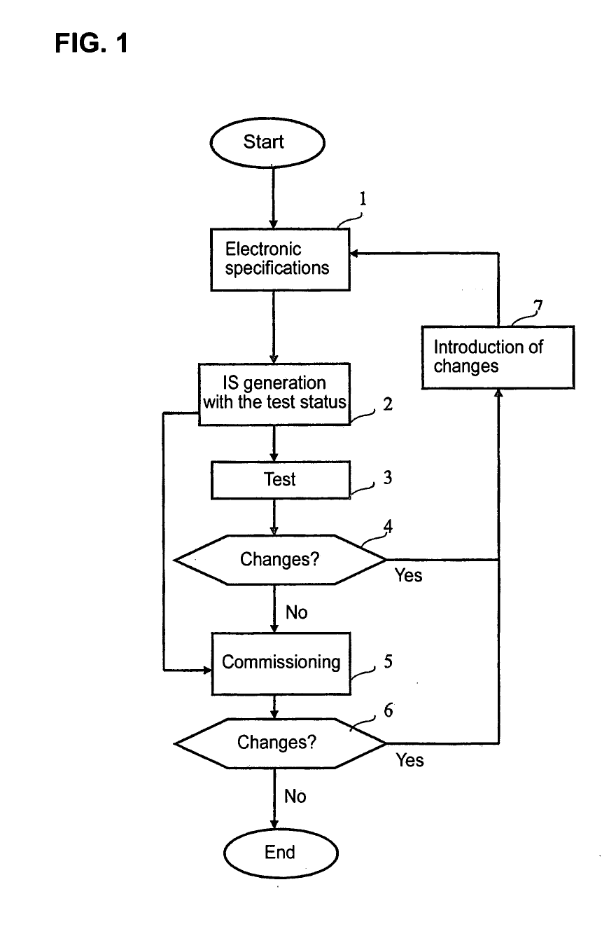

FIG. 1 is a block diagram of a method according to the invention;

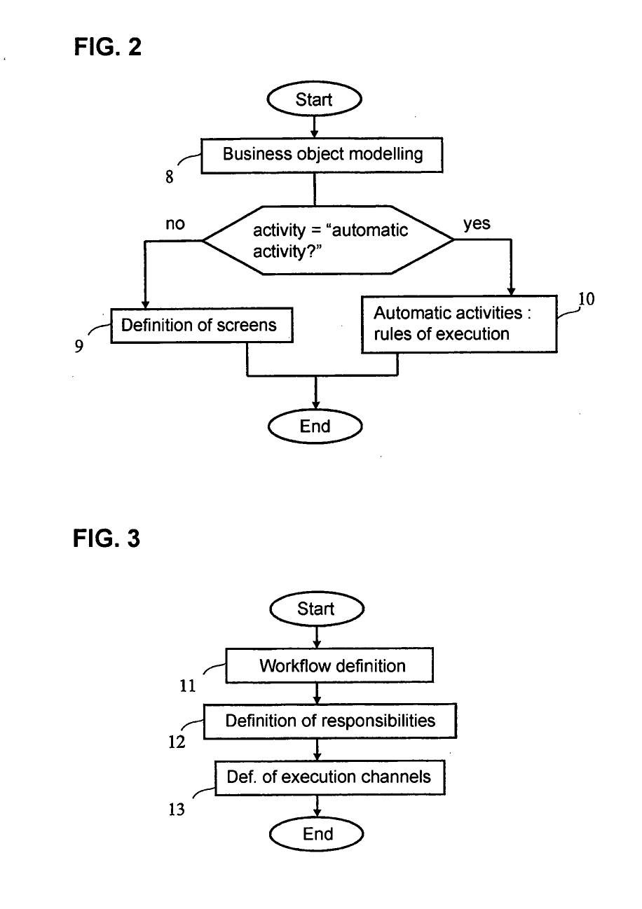

FIG. 2 is a diagram giving details on the electronic specification step of FIG. 1;

FIG. 3 is a diagram giving details on the business process modeling step of FIG. 2;

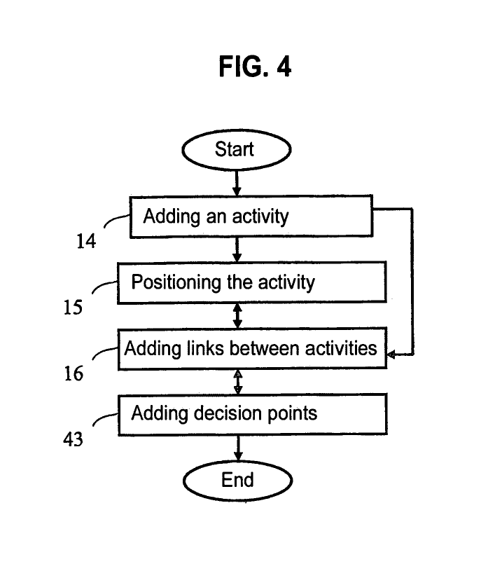

FIG. 4 is a diagram giving details on the workflow definition step of FIG. 3;

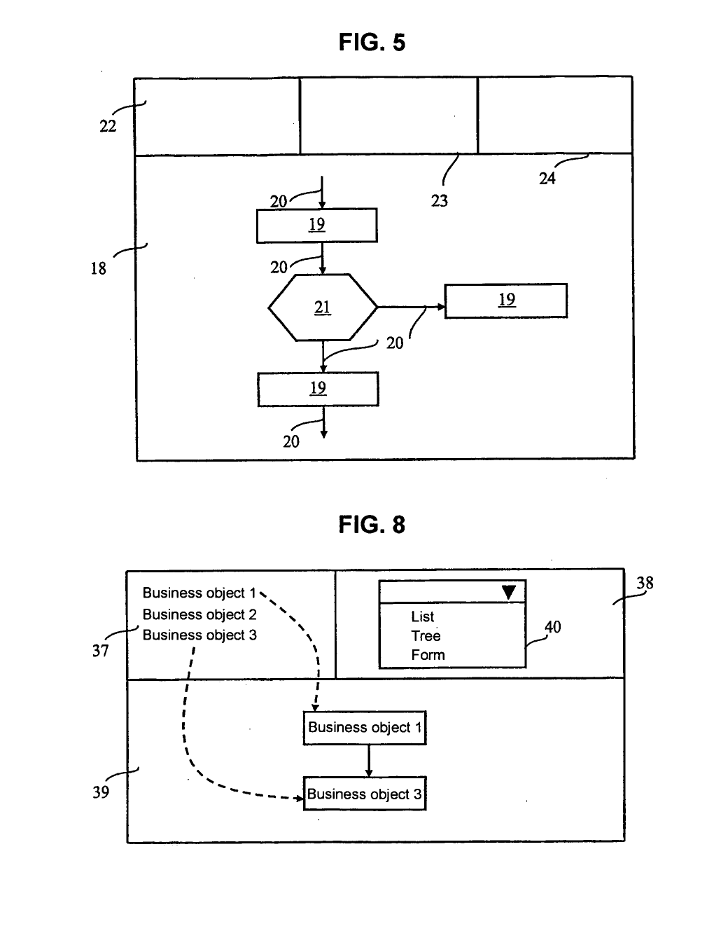

FIG. 5 is the illustration of a graphic interface used for modeling the workflow,

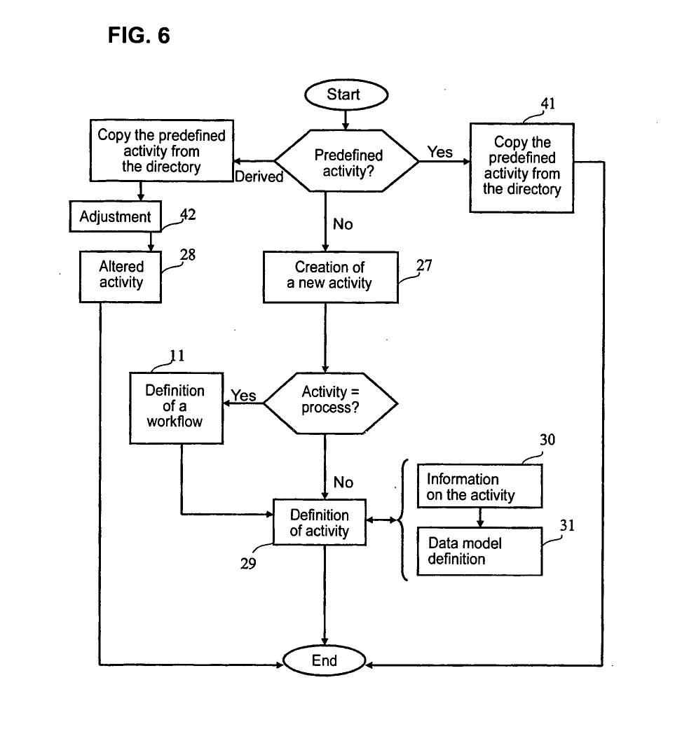

FIG. 6 is a diagram giving details on the activity addition step of FIG. 4;

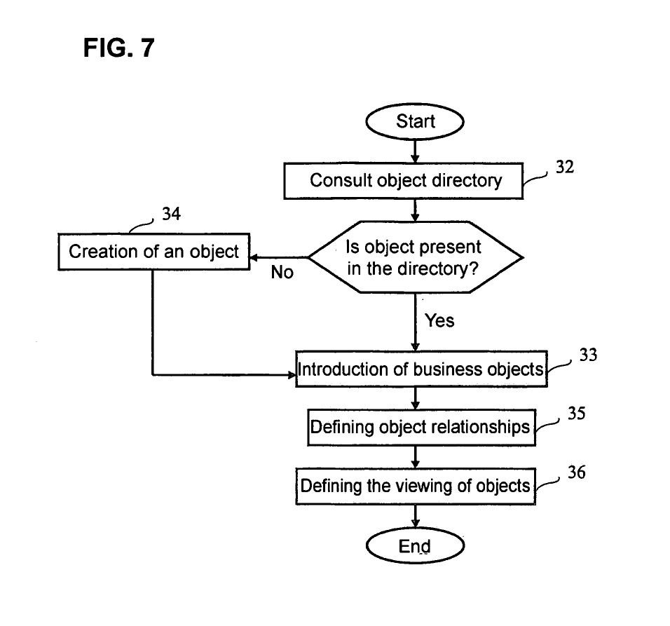

FIG. 7 is a diagram giving details on the data model definition step of FIG. 6;

FIG. 8 is an illustration of a graphic interface used for defining the data model;

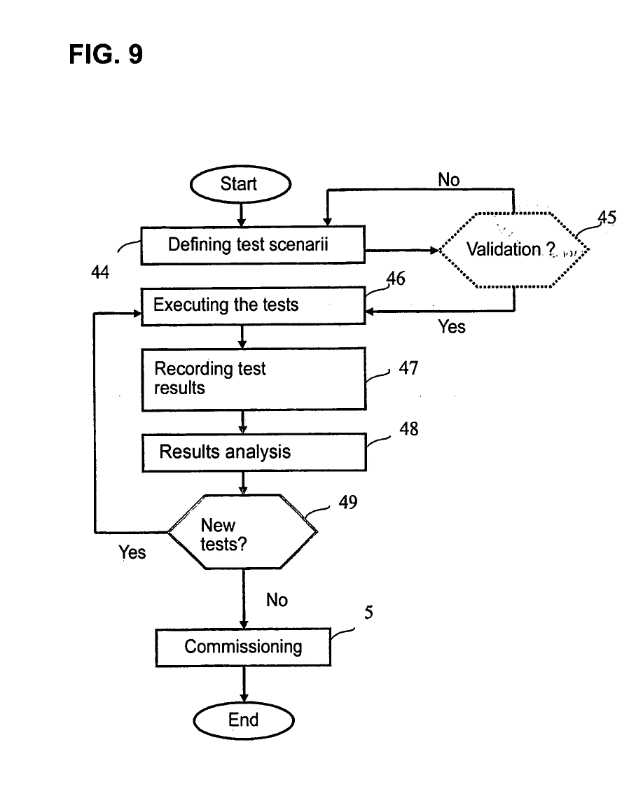

FIG. 9 is a diagram giving details on the test step of FIG. 1.

In this example, the block diagram of a method according to the invention comprises the following steps (FIGS. 1, 2 and 3):
a determination of electronic specifications (Block 1) including the modeling of the business processes (Block 8) and defining, if need be, the work screens (Block 9), rules for executing automatic activities (Block 10), said modeling of the business processes comprising a definition of the workflows (Block 11), a definition of responsibilities (Block 12), an execution channel (Block 13), this determination corresponding to version n of the information system the status of which is “specification”,
a generation of the information system corresponding to version n in a test status (Block 2), i.e., that the version is usable because the work screens and other functions required for use are now available,
a step for actually testing version n of the information system (Block 3) or directly a commissioning step (Block 5) corresponding to an operation status of version n,
if the requirement for change occurs after the tests (Block 4) or the commissioning (Block 5), new electronic specifications and thus a new version n+1 in a “specification status” are elaborated from the introduction of the changes (Block 7).

An automatic activity is called an automatically executed activity by the information system without involving an actor from the corporation.

A workflow or automatic activity engine executes these activities according to execution rules defined during the definition of the information of an automatic activity in the phase for electronic specifications. This is why it may be stated that the automatic activities are assigned to the workflow responsibility which then appears as a responsibility of a user in its own right, except that the user is the workflow, i.e., the system.

When a new version of the information system is defined, in fact a new version of the information system is created with the status “specification”. The same version follows the different steps of the method and successively passes from the “specification” status to the “test” status, and finally if need be, to the “operation” status.

For example in a corporation, version n is in operation.

A marketing department manager needs to change certain activities of his/her business processes. He/she therefore generates a version n+1 of the information system, based on version n, and adds changes to the electronic specifications.

Meanwhile, the sales department manager also wishes to make changes to certain of his/her business processes, he/she sees that an n+1 version is being specified and he/she makes the necessary changes to it.

When the specifications are finished, the different managers agree in order to put the version in the “test” status and then once the tests are finished, in the “operation” status.

Thus, all the changes are taken into account in this same version n+1. If the tests carried out on n+1 are unsatisfactory, version n+1 may switch back to the “specification” status.

There can be only one version in a same status. On the other hand, while a version n has the “operation” status, version n+1 may be in the “specification” status.

All the steps of the method described above are achieved electronically and/or automated in the application.

The definition of the business processes corresponds to the Process Book generally written by the integrators and drawn up in paper form.

The diagram of FIG. 4 corresponds to the definition of the workflow, i.e., the definition of the different activities of the corporation and the order in which these activities are executed. This step itself is a process consisting of several steps:

adding an activity (Block 14),

positioning an activity in the business process (Block 15),

adding links between the activities (Block 16),

adding decision points (Block 17).

Modeling of the workflow is produced graphically (FIG. 5) by means of an interface called an electronic white board notably providing:

on a first portion 18 of the display screen of a computer:
a graphic illustration of the activities of a workflow by a geometrical shape such as a rectangle 19,
an illustration of the links between activities by means of lines 20 joining said activities,
an illustration of decision points by a geometrical, for example hexagonal shape 21,

on a second portion 22 of the display screen of a computer, input of complementary information to an activity,

on a third portion 23 of the display screen of a computer, input of responsibilities for each activity,

on a fourth portion 24 of the display screen of a computer, input of the execution channel(s) 25 by means of selection lists 26 (Web, UMTS, fax . . . ).

The activity addition step illustrated in FIG. 6 consists of adding an activity to compose a workflow, this activity may be created (Block 27) because it is new or predefined or even issued from a predefined and subsequently adjusted activity (Block 28).

When an activity does not exist as a predefined activity and when adjustment of a predefined activity is not sufficient, a new activity (Block 27) is created by defining a certain number of pieces of information.

If the activity itself corresponds to a workflow, the “workflow definition” process should be followed (Block 11) in order to obtain the finest grain size as possible.

If the activity is an elementary activity, then the activity definition process should be followed (Block 29).

The definition of an activity whether it is predefined (in this case, these steps have already been performed) or not, therefore comprises the following steps:
collection of information on the activity: name, goal, type. It is notably specified whether the activity is executed by the user or automatically by the system (automatic activity) (Block 30).
definition of the data model of each activity (Block 21), each activity being executed in a well specified context. Indeed, when business activities are carried out, the data or attributes of one or several business objects are in fact acted upon.

A business object is called a set of logically grouped attributes, characterizing an elementary entity of a business.

In the exemplary embodiment, each attribute may be associated with a type of default viewing, i.e., it is specified in the definition of each attribute to which level of detail it corresponds and it should be visible.

The context of an activity therefore corresponds to an environment of business objects otherwise called a data model. The business objects within this model are related to each other through relationships. For example, in the client address management activity, two business objects may be included: “Client” and “Address”. In this model, all the addresses for a giving client are seen. The “Client” business object is therefore represented as the parent of “Address” and several addresses are listed for a client.

Defining the data model (FIG. 7) of an activity consists of:
consulting a predefined directory of business objects (Block 32),
if the wanted business object(s) are found in this directory, they are introduced into the data model (Block 33),
if the wanted business object(s) are not in the directory, they may be created (Block 34) and then introduced into the data model (Block 33),
   As soon as the required business objects have been added, relationships between them must be defined (Block 35),

These relationships may mean a relationship of 1 to 1 or 1 to n.

The relationship direction between the objects is normalized. For example linking an object A to an object B means that A is the child of B. These relationships are used upon executing the activity for dynamically linking the business objects. In a standard information system, the business objects are already linked to each other by the editor of the system; consequently the links are rigid. This is the main reason of the inflexibility of existing information systems.

Conversely, in the invention, the business objects are dynamically linked in each activity, the links are therefore flexible according to the needs of each activity.
for each business object, it is specified how the user will see the data of the business objects (Block 36), of an activity in the information system in production.
A business object may be included in different activities and be shown in each activity differently. For example, in the activity “see the hierarchy of a client”, the “client business object” is shown as a tree. The different viewing types may for example be classified as follows: brief/moderately detailed/very detailed/list form/tree/tree-list/list-form, etc.
This step is intended to be extremely simple and enables any user who is not a computer scientist to describe in a suitable vocabulary how he/she wants to see the data on the work screens.

Definition of the data model is achieved by means of a graphic interface (FIG. 8) wherein:
on a first portion of the display screen of a computer, is located the directory where the business objects are listed (Block 37),
on a second portion of the display screen of a computer (Block 39), is found the graphic representation of the data model of the activity being created, it is then appropriate to drag the business object from the window of the directory to the window of the data model in order to add it, where it is represented as a geometrical form. Next, the links between the business objects should be added by materializing them by lines,
on a third portion of the display screen of a computer (Block 38), a list of selections (Block 40) is displayed so that the user specifies how he/she wants to see the data (attributes) of the business objects in the information system in production.

Certain standard activities are often involved in the business processes and consequently they may be predefined and stored in a directory and then, if need be, a copy will be made and added to the workflow (Block 41).

A predefined activity allows a workflow to be composed very rapidly. It contains information on the activity, the data model and further the work screen associated with this activity—if necessary—is predefined.

The activities (Block 28) created from predefined activities may correspond to an adjustment (Block 42) directed to exactly meeting the needs of the corporation: adjustment of the data model, adjustment of the work screens, etc. This adjustment is performed from a copy of the predefined activity made in this directory. If the predefined activity already meets the needs of the corporation, then it is unnecessary to proceed with this adjustment.

Next, in the definition of the workflow (FIG. 4) the positioning of each activity should be specified (Block 15): each newly created or added activity from a directory of activities has a definite place in the linking of the workflow.

They are therefore linked by links (Block 16) and decision points (Block 43). These links and these decision points when the system is in the test or operation status, allow the activities to be specified which may be carried out subsequently to a given activity. Decision rules are defined for each point of decision.

The following activities may thereby be determined according to the decision rules defined for the decision points (Blocs 16 and 43) automatically.

Consequently, in the production phase (“operation status”) (Block 5), the user is completely guided between the different process screens when he/she is working, for example he/she switches from one activity to another by means of navigation buttons of the “following” or “previous” type which tell him/her which are the possible activities.

This form of guiding is automatically generated from links (Block 16) and decision points (Block 43) drawn during the electronic specification step (Block 1).

Once the workflow is defined, the step for assigning responsibilities (Block 12) proceeds in the following way:

Each business object activity is executed by one or several actors.

Each actor in the corporation has one or several responsibilities, also called “title”. For example: “Marketing” is the name of the responsibility specifically assigned to the marketing people of the corporation, “Client Service Agent” is a title of an employee working for the customer service.

The titles are defined for each corporation in a step for describing the organization of the corporation. They are therefore specific to each corporation.

In this step, the title(s) executing the activity are specified for each activity.

Next, the execution channel(s) used for each workflow (Block 13), i.e., an internal, Internet, UMTS, fax . . . application, are defined.

After this last step, modeling of the business processes is completed, two selections are then possible:
if the business activity is intended for a user, there is definition and generation of work screens (Block 9),
if this is a business activity running in the background such as an automatic activity or activity assigned to an automatic activity engine for which the related rules of execution must be defined (Block 10).

The work screens (Block 9) are generated:
either automatically from methods for representing the business objects specified upon defining the screens and at the viewing level by default fields of the business objects,
or, if the desired representation does not correspond to a predefined representation method, by defining the desired representation of the business objects and adding the corresponding fields.

Once the electronic specifications are made, generation of the n version (test status) information system (Block 2) is automatic and results in a system ready to execute the activities of the user.

The validation test (Block 3) itself is a process (FIG. 9), with which the model processes may be validated before passing into the production phase.

This test process may include several steps:
a definition of test scenarii (Block 44) which is an activity where the scenarii are defined relatively to the modeled business processes,
validation of test scenarii, this activity being an option (Block 45),
an execution of the tests (Block 46),
a recording of the results (Block 47),
an analysis of results (Block 48),
if need be, the execution of new tests,
if the tests are satisfactory, the test version of the information system may switch to the production step (Block 5).

The commissioning step (Block 5) is an activity enabling the information system operating according to the modeled business processes (operation status) to be made available to the actors (users)

This step may itself be a process with approval steps on one or more levels before authorizing commissioning.

Generation of documentation may be contemplated.

During the elaboration of a standard information system, this step is separate and concurrent with specifications whereas in the method according to the invention, it results from electronic specifications: it is generated automatically.

Generation of documentation from model processes according to the method of the invention is a guarantee of quality: work is always performed in the described way and what is written down always corresponds to the workflow. The invention is not limited to the example described earlier.

For example, the system applying the method according to the invention may be connected with EAI.

It should be noted that the workflow (automatic activities) engine described in the method according to the invention, is more complete than a standard workflow engine. Indeed, it is integrated with the information system, generated according to the method, which handles all the processes both internal and external.

For example, in the case of an extranet process which involves a workflow engine: a client connects to the Web site of the corporation, fills in a form, and at the same time wants to communicate with the different actors of the corporation. The Internet communication will be immediately transmitted to the relevant actor(s) of the corporation. This may be done at the same time as the state of the form is changed during the different activities of the process. A standard workflow engine will not be able to model such a process. Indeed, in this example, there are two business processes executed in parallel: communication with the actors of the corporation and follow-up of the form. Communication is not a process belonging to the workflow processes. It may be not modeled in a standard workflow engine. The standard workflow engines only allow a limited vision over the portions of the business processes which are automated. In the system according to the method of the invention, it is possible to have a global end-to-end view of the processes whether they are automated or not.

Moreover, a workflow engine may perfectly be connected with the method according to the invention.

1. A method for automating the implementation and updating of an information system, said method comprising the following phases:
an electronic specification phase corresponding to a first status of a given version of the information system and notably comprising the modeling of business processes, said modeling of business processes including a definition of workflows and a definition of responsibilities,
a phase for automatically generating the information system from electronic specifications corresponding to a second status of a given version of the information system,
a commissioning phase corresponding to a third status of a given version of the information system and including automatic deployment of said operational version of the information system over different execution channels,
if a change to the information system is made after commissioning, an adaptation phase including the return to the electronic specification phase and thus the creation of a new version corresponding to a new first status of the information system,
this method automatically handling the statuses relatively to each other of the different versions of the information system.

2. The method according to claim 1, wherein said first status is a specification status, said second status is a test status and said third status is an operation status.

3. The method according to claim 1, wherein the changes brought to the electronic specifications are implemented in real time.

4. The method according to claim 1, wherein the electronic specification phase comprises the definitions of the work screens of the different users and/or rules for executing automatic activities.

5. The method according to claim 1, wherein the electronic specifications comprise a detailed description with a very fine grain size so as to include all the information allowing the information system to be generated.

6. The method according to claim 1, wherein, during the modeling of business processes, one or more channels for executing each activity are defined in order to be able to automatically generate the adequate items of the information system.

7. The method according to claim 1, wherein the handling and distribution of the specification documents are carried out from electronic specifications dynamically.

8. The method according to claim 1, wherein the commissioning phase is preceded by a validation test phase.

9. The method according to claim 8, wherein said validation test takes place on the version of the information system in the test status.

10. The method according to claim 1, wherein test scenarii are defined for the validation test.

11. The method according to claim 8, wherein if the result of the test is positive, the phase for commissioning the information system begins.

12. The method according to claim 8, wherein if the test is negative, there is introduction of changes, return to the electronic specification phase and repetition of the following phases until the test is positive.

13. The method according to claim 1, wherein the modeling of the business processes taking into account channels for executing each activity, during the generation of the information system, causes the generation of items for each channel such as work screens, synchronization functions.

14. The method according to claim 1, wherein the commissioning phase comprises the replication of the last tested version of the information system on a server of the corporation and then its automatic deployment over the different terminals or client stations.

15. The method according to claim 1, wherein said deployment over the client stations is directly achieved from a user identifier thereby giving limited access adapted to a certain number of activities.

16. The method according to claim 1, wherein, during generation of a new information system as a result of a change, for example in a business process, the client stations automatically detect a new version of the information system and are updated.
